(19) United States
(12) Patent Application Publication
(10) Pub. No.: US 2005/0236405 A1
(43) Pub. Date: Oct. 27, 2005

(54) Cold start control system for microwave cooking appliance

(75) Inventor: Robert A. Schulte, Williamsburg, IA (US)

Correspondence Address: DIEDERIKS & WHITELAW, PLC;#301, 12471 Dillingham Square, Woodbridge, VA, 22192, US

(73) Assignee: Maytag Corporation

(21) Appl. No.: 10/991,828

(22) Filed: Nov. 19, 2004

Related U.S. Application Data
(60) Provisional application No. 60/560,281, filed on Apr. 8, 2004.

(51) Int. Cl. H05B 6/66

(52) U.S. Cl. 219/715

(57) ABSTRACT

A microwave cooking appliance includes a control system which, at initial start-up of a microwave energy generating magnetron, assures that the timing of power supply switching is precisely controlled. In accordance with a preferred embodiment of the invention, power to a primary winding of a half-wave voltage-doubling magnetron power supply is switched on ninety degrees after a zero crossing of line voltage. In this manner, the power on timing coincides with the midpoint of a charging half-cycle of a power supply capacitor to obtain consistent and minimum open circuit voltage starts whenever the magnetron is activated from a cold start.

### CROSS-REFERENCE TO RELATED APPLICATION

The present application claims the benefit of U.S. Provisional Patent Application Ser. No. 60/560,281 entitled “Cold Start Control System for Microwave Cooking Appliance” filed Apr. 8, 2004.

### BACKGROUND OF THE INVENTION

1. Field of the Invention

The present invention pertains to the art of cooking appliances and, more particularly, to a system for controlling a microwave heating device upon cold start so as to obtain consistent and minimum open circuit voltage starts.

2. Discussion of the Prior Art

There exist a wide range of cooking appliances on the market. Many of these cooking appliances are designed for use in cooking various types of food products in different ways. For instance, where more conventional cooking appliances generally relied upon radiant energy as the sole heat source, more recent trends combine a radiant heat source with convection, microwave or conduction heating techniques, thereby increasing the versatility of the cooking appliance while potentially shortening required cook times. In particular, the prior art contains examples of appliances that combine radiant and convection cooking; convection, microwave and radiant cooking; and microwave, convection and conduction heating techniques.

When employing microwave heating, either alone or in combination with other heating techniques, it would be desirable to enhance the operation of the microwave generator during initial start-up in an attempt to get consistent and minimum open circuit voltage starts for the oven magnetron. To address this concern, it is possible to control the timing of power supply switching to a transformer. Without the control system of the present invention, it has been found that an incorrect timing of power at start-up in a typical microwave oven can undesirably result in a spike on the transformer, as well as an additional voltage load on a system capacitor as represented in FIG. 8.

Based on the above, there exists a need in the art for a control system which assures the optimum timing of the power supply to the transformer of a magnetron of a microwave cooking appliance upon initial start-up in order to get consistent and minimum open circuit voltage starts for the magnetron of the cooking appliance.

### SUMMARY OF THE INVENTION

The present invention is directed to a microwave cooking appliance including a control system which, at initial start-up of a microwave energy generating magnetron, assures that the timing of power supply switching is precisely controlled. In accordance with a preferred embodiment of the invention, a semiconductor device is employed to control the power to a primary winding of a half-wave voltage-doubling magnetron power supply. In accordance with the most preferred embodiment of the invention, the power to a transformer for the magnetron is switched on ninety degrees after a zero crossing of line voltage. In this manner, the power on timing coincides with the midpoint of a charging half-cycle of a power supply capacitor. To carry out the invention, a controller preferably regulates the power timing to obtain desired consistent and minimum open circuit voltage starts whenever the magnetron is activated from a cold start.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is an upper right perspective view of a cooking appliance incorporating a combination heating system constructed in accordance with the present invention;

FIG. 2 is a front view of the cooking appliance of FIG. 1 with a cooking chamber of the appliance exposed;

FIG. 3 is an upper right perspective view of the cooking appliance of FIG. 1 with an outer cabinet portion of the appliance removed;

FIG. 4 is a cross-sectional side view of the cooking appliance constructed in accordance with the present invention;

FIG. 5 is a plan view of a top portion of a cooking chamber of the appliance;

FIG. 6 is schematic drawing of a control circuit in accordance with the present invention;

FIG. 7 is graph showing input power, secondary transformer voltage and capacitor voltage experienced in connection with the start-up control system of the invention; and

FIG. 8 is a graph, similar to that of FIG. 7, showing how a start-up voltage spike occurs without the control system of the invention.

### DETAILED DESCRIPTION OF THE PREFERRED EMBODIMENT

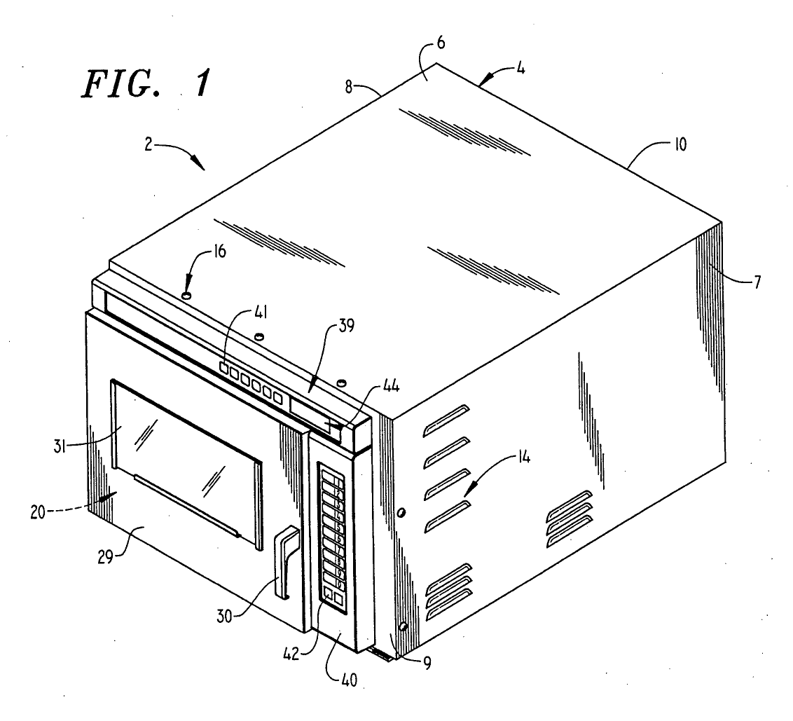

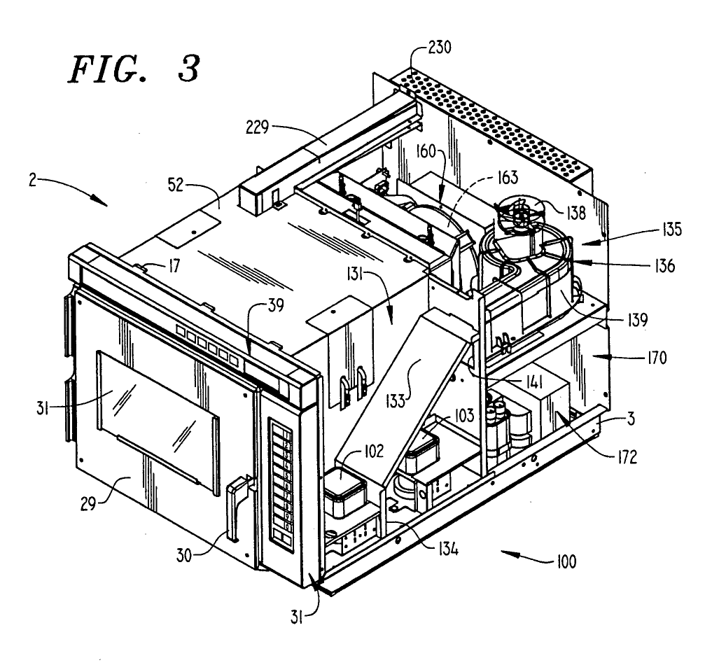

With initial reference to FIGS. 1-3, a cooking appliance constructed in accordance with the present invention is generally indicated at 2. As shown, cooking appliance 2 includes a base frame 3 to which is secured an outer cabinet shell 4 having top and opposing side panels 6-8. Cooking appliance 2 is also provided with a front face or wall 9 and a rear panel 10. Arranged at a lower portion of front wall 9 is an intake air vent 12 through which, as will be discussed more fully below, an ambient air flow enters into cabinet shell 4. In addition, cabinet shell 4 includes a plurality of air discharge vents, indicated generally at 14, arranged on side panel 7. Vents 14 enable cooling air to exit from within cooking appliance 2, thereby removing heat from within cabinet shell 4. Cabinet shell 4 is secured over base frame 3 through a plurality of fasteners 16, with the fasteners 16 arranged along front wall 9 being secured at tabs 17 (see FIG. 3).

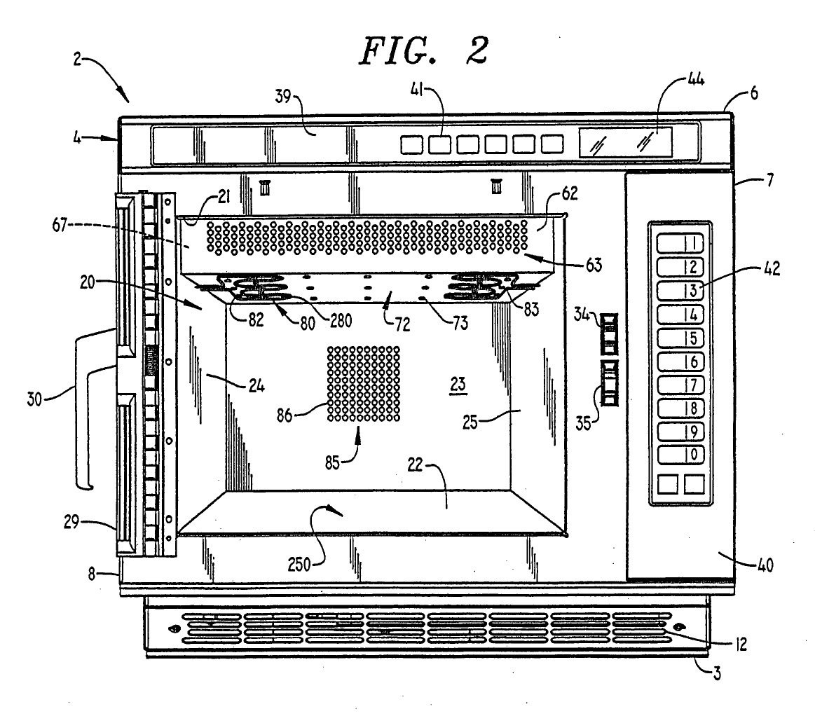

As best seen in FIG. 2, arranged within cabinet shell 4 is a cooking chamber 20 having top, bottom, rear and opposing side walls 21-25. In a manner known in the art, a door 29 is pivotally mounted to front wall 9 to selectively enable access to cooking chamber 20. Toward that end, door 29 includes a handle 30 and a window 31 for viewing the contents of cooking chamber 20 during a cooking operation. Although not shown, window 31 includes a screen (not shown) that prevents microwave energy fields from escaping from within cooking chamber 20 during a cooking operation. Handle 30 is adapted to interconnect to upper and lower latching mechanisms 34 and 35 so as to retain door 29 in a closed position and prevent operation of cooking appliance 2 whenever door 29 is opened.

Cooking appliance 2 is shown to include upper and side control panels 39 and 40, each of which includes a respective set of control buttons or elements 41 and 42. The sets of control elements 41 and 42, in combination with a digital display 44, enable a user to establish particular cooking operations for cooking appliance 2. For instance, control elements 41 can be used to establish the heating parameters of cooking appliance 2, while control elements 42 enable stored cooking times and/or operations to be readily selected. Since the general programming of cooking appliance 2 does not form part of the present invention, these features will not be described further herein.

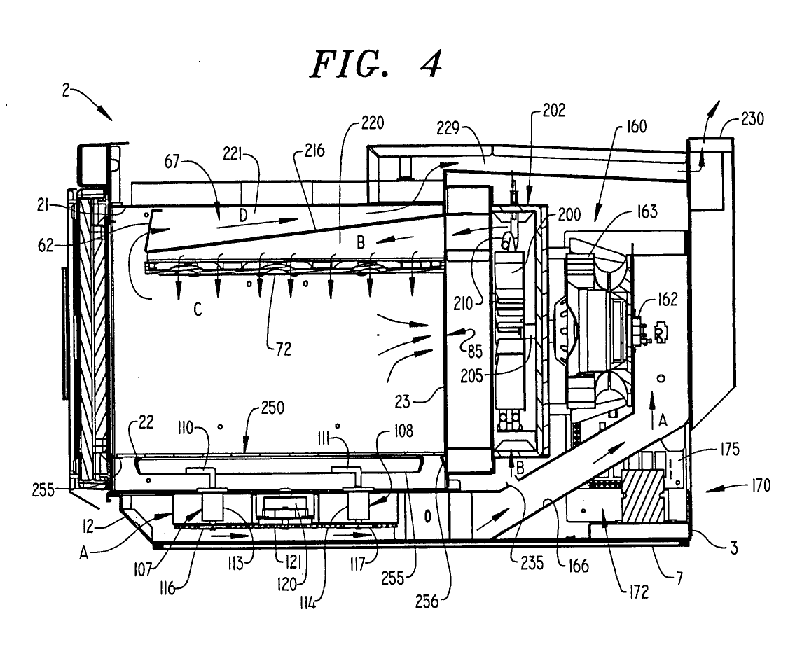

As further shown in FIG. 2, cooking appliance 2 includes a plenum cover 62 arranged at an upper portion of cooking chamber 20. As will be discussed more fully below, plenum cover 62 includes a plurality of openings, indicated generally at 63, that enable an exhaust air flow to pass from cooking chamber 20. Arranged behind plenum cover 62 is a bifurcated air plenum 67 (see FIG. 4) that provides air flow management for cooking chamber 20 during a cooking operation. More specifically, an air emitter plate 72 extends rearward from a lower portion of plenum cover 62 to rear wall 23 of cooking chamber 20. In accordance with a preferred embodiment of the invention, air emitter plate 72 includes a plurality of strategically placed openings 73 that are exposed to a lower portion of bifurcated plenum 67. A radiant heating device 80, including first and second radiant heating elements 82 and 83 (see FIG. 2), preferably extends along air emitter plate 72. More specifically, radiant heating elements 82 and 83 are constituted by sheathed, electric resistive elements, each having a serpentine-like pattern that extends fore-to-aft across a section of air emitter plate 72. In the most preferred embodiment, each heating element 82, 83 is capable of delivering 900 watts of energy into cooking chamber 20. More preferably, each heating element 82, 83 is configured to produce 60 watts/in² of power. Cooking appliance 2 also includes a convection air intake vent 85 having a plurality of convection air openings 86 positioned on rear wall 23 of cooking chamber 20.

As shown best with reference to FIGS. 3 and 4, cooking appliance 2 includes a microwave heating device 100 incorporating first and second magnetrons 102 and 103 (see FIG. 3) that are adapted to generate and direct a combined microwave energy field into cooking chamber 20. As seen in FIG. 4, first and second magnetrons 102 and 103 include respective first and second rotating antenna assemblies 107 and 108. Each rotating antenna assembly 107, 108 includes an antenna portion 110, 111, a housing portion 113, 114 and a gear member 116, 117 respectively. In accordance with a preferred form of the invention, antenna assemblies 107 and 108 are arranged below bottom wall 22 of cooking chamber 20. In further accordance with the invention, antenna portions 110 and 111 are rotated so as to develop a uniform, constructive standing microwave energy field within cooking chamber 20. That is, antenna assemblies 107 and 108 are rotated by a drive motor 120 having a drive gear 121 which is drivingly connected to each of gears 116 and 117 of antenna assemblies 107 and 108, preferably through a gear train (not shown).

Referring to FIG. 3, magnetrons 102 and 103 are arranged in a microwave housing portion 131 of cooking appliance 2. Microwave housing portion 131 includes an angled divider 133 and a vertical divider 134. Although not shown, vertical divider 134 is formed with an opening leading beneath magnetron 102. In order to prevent magnetrons 102 and 103 from overheating, cooking appliance 2 is provided with a microwave cooling system 135 that includes a blower assembly 136 which is drivingly connected to a drive motor 138 positioned within a duct 139. Duct 139 extends from drive motor 138 to an opening 141 arranged below angled divider 133. With this arrangement, activation of cooking appliance 2 causes drive motor 138 to rotate, whereby blower assembly 136 establishes a cooling air flow. The cooling air flow is guided through opening 141 toward magnetron 103 due to the presence of angled divider 133. The cooling air flow circulates about magnetron 103, through vertical divider 134, across magnetron 102 and up along angled divider 133, in order to provide a cooling effect for magnetrons 102 and 103, before exiting cooking appliance 2 through vents 14.

In addition to microwave cooling system 135, cooking appliance 2 includes an air intake system 160 having an associated drive motor 162 coupled to an impeller 163. Drive motor 162 rotates impeller 163 so as to draw in an ambient air flow A through intake air vent 12. Intake air vent 12 leads to an intake air duct 166, while passing about drive motor 120 for antenna assemblies 107 and 108. A majority of the air flow A is circulated within a rear control housing portion 170 in order to cool a plurality of electronic components 172, including a main control board 175 which is adapted to receive input and/or programming instructions through control elements 41, 42 in order to establish and set various cooking operations for cooking appliance 2.

In addition to driving impeller 163, drive motor 162 operates a convection fan 200 positioned within a convection fan housing 202 that, in the embodiment shown, is arranged behind rear wall 23 of cooking chamber 20. More specifically, convection fan 200 is drivingly connected for concurrent rotation with impeller 163 through a drive shaft 205 such that operation of drive motor 162 is translated to convection fan 200 to establish a convective air flow B. Convective air flow B is passed over a convection air heating element 210 and delivered into cooking chamber 20 through openings 73 in air emitter plate 72. More specifically, as will be discussed further below, convective air flow B is directed into bifurcated air plenum 67 before passing into cooking chamber 20.

In further accordance with the preferred form of the invention, bifurcated air plenum 67 includes an angled divider plate 216 that defines a tapered air delivery portion 220 and a corresponding tapered exhaust portion 221. In the embodiment shown, air delivery portion 220 is essentially defined by air emitter plate 72, angled divider plate 216 and part of rear wall 23, while exhaust portion 221 is defined by plenum cover 62, top wall 21 and angled divider plate 216. In any event, air flow B developed through operation of convection fan 200 is heated by heating element 210, directed into air delivery portion 220 of bifurcated air plenum 67 and then lead into cooking chamber 20 through openings 73. The tapering of air delivery portion 220 is provided so that air initially entering bifurcated air plenum 67 from convection fan 200 passes through openings 73 in air emitter plate 72 with substantially the same pressure as air reaching an end portion (not separately labeled) of tapered air delivery portion 220.

As a portion of the cooking operation is constituted by convection heating, convective air flow B circulates about cooking chamber 20. This heated air flow has been found to particularly enhance the even cooking of a food item. As further represented in FIG. 4, a first portion of convective air flow B passes into convection air intake vent 85 through openings 86. The convective air flow B is heated/reheated by heating element 210 before being passed back into cooking chamber 20. At the same time, a second, preferably smaller portion of convective air flow B passes through openings 63 in plenum cover 62 and is directed out of cooking appliance 2. More specifically, plenum cover 62 leads into tapered exhaust portion 221. The exhaust air flow D entering into tapered exhaust portion 221 is passed upward into an exhaust duct 229 before exiting through an exhaust outlet 230 that, in the embodiment shown, is arranged at an upper rear portion of cooking appliance 2. To replace the lost air flow, convection fan 200 preferably draws or siphons a portion of air flow A. For this purpose, one or more openings 235 are provided in duct 166 in order to introduce fresh ambient air to the overall, circulating air flow. In this manner, certain cooking effluents, including moisture and steam, exit cooking chamber 20 through exhaust outlet 230, while a fresh supply of air is introduced into the remaining, recirculated air flow due to the presence of opening(s) 235.

In further accordance with the present invention, cooking appliance 2 includes a conductive heating device 250 that, in the most preferred form of the invention, defines bottom wall 22 of cooking chamber 20. Conductive heating device 250 is preferably constituted by a ceramic stone plate adapted to support food items within cooking chamber 20. Conductive heating device 250 advantageously provides a thermal conduction path for heating and browning of a food item. More specifically, upon activation of cooking appliance 2, radiant heat produced by heating elements 82 and 83 combines with convective air flow B generated by convection fan 200 to heat conduction heating device 250. Conductive heating device 250 is transparent to microwave energy so that microwave energy fields emitted by magnetrons 102 and 103 pass upward into cooking chamber 20 and further contribute to the overall cooking operation. In further accordance with the invention, conductive heating device 250 is supported upon a plurality of support brackets, such as those indicated at 255 and 256, to enable or facilitate removal of conductive heating device 250 for cleaning or other purposes.

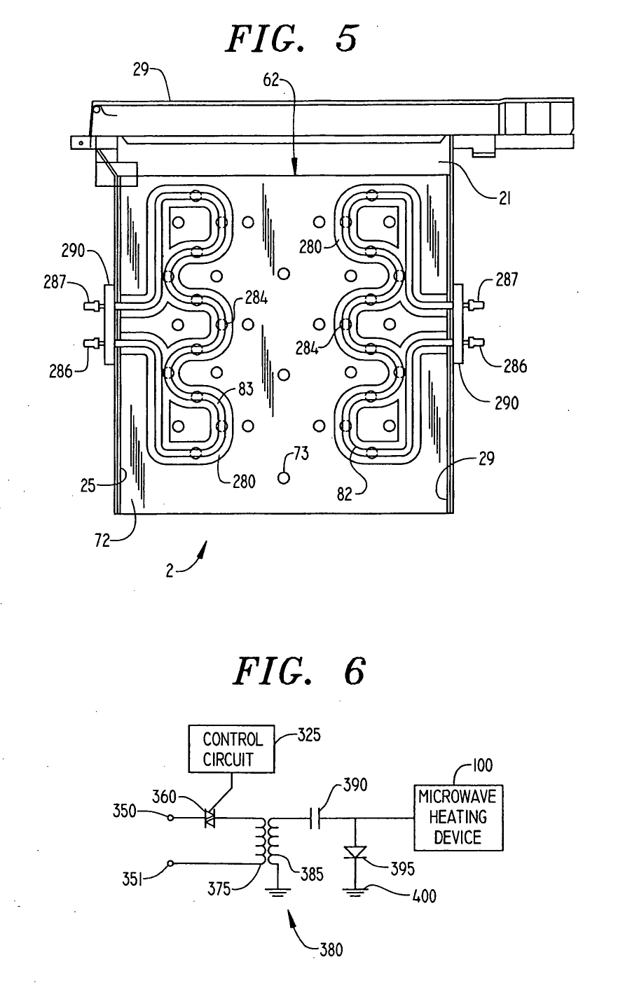

With particular reference to FIG. 5, air emitter plate 72 is preferably formed from anodized cast aluminum and provided with a pair of fore-to-aft extending recessed channels 280. Recessed channels 280 are provided with a plurality of openings 284. Heating elements 82 and 83 are nested within recessed channels 280 adjacent openings 284. As shown, each heating element 82, 83 includes a pair of electrodes 286 and 287 spaced from side walls 24 and 25 by an insulator 290. With this mounting arrangement, not only do heating elements 82 and 83 provide a source of radiant heat, but convective air flow B passing through openings 284 is heated by the additional thermal energy generated by heating elements 82 and 83 as air flow B passes from air delivery portion 210 of air plenum 67 into cooking chamber 20. Therefore, by being routed between, across and around respective ones of the various strategically placed openings 284, heating elements 82 and 83 evenly distribute thermal and infrared energy to the food being cooked.

With this overall combined cooking arrangement, a food item, for example, an open-faced sandwich placed within cooking chamber 20, can be exposed to a four-way combination cooking operation, i.e. radiant, microwave, convection and conductive heating techniques. The combination of the aforementioned heating techniques serves to cook the food item in an expeditious manner, while maintaining the required food quality. In addition, combining the aforementioned heating techniques enables cooking appliance 2 to be readily adapted to cook a wide range of food items in an efficient and effective manner, while also establishing an overall compact unit.

The above description of the preferred construction of cooking appliance 2 is provided for the sake of completeness and is covered by U.S. patent application entitled “Cooking Appliance including Combination Heating System” filed on even date herewith and incorporated by reference. The present invention is particularly directed to a control system and method for providing an optimum timing of power to magnetrons 102 and 103 of microwave heating device 100. With initial reference to FIG. 6, a control circuit 325 of cooking appliance 2 is employed to regulate power, such as from an AC source providing 220 volts across power lines 350 and 351, by means of a semiconductor 360 to a primary winding 375 of a transformer 380. Transformer 380 has a secondary winding 385 that leads through a capacitor 390 to an anode of microwave heating device 100. This FIG. also depicts a diode 395 in line to ground 400 downstream of capacitor 390.

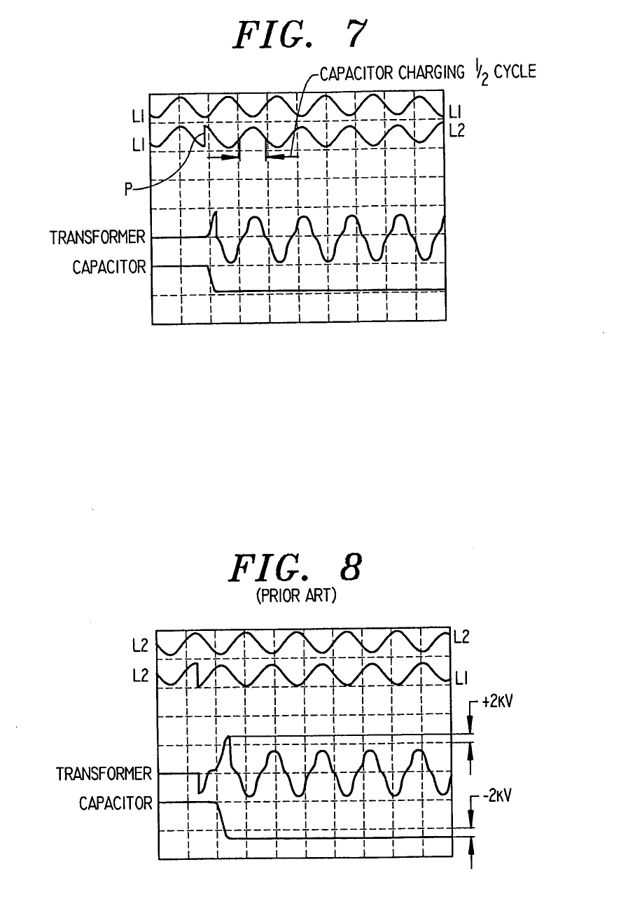

The invention is particularly concerned with controlling the timing of power to primary winding 375 of transformer 380, which defines a half-wave voltage-doubler magnetron power supply, in order to get consistent and minimum open circuit voltage starts for magnetrons 102 and 103 upon cold start operations. More specifically, the timing of the power supply switching is precisely controlled to ensure the minimum open circuit voltage start. To this end, control circuit 325 regulates the switching of the semiconductor 360 that controls the power to primary winding 375 such that power is switched on 90 degrees after a zero crossing of the line voltage. This is perhaps best illustrated in FIG. 7 wherein the primary switch point is indicated at P. As can be seen from this graph, the zero crossing of the line voltage coincides with the midpoint of a charging half-cycle for capacitor 390 associated with the power supply for microwave heating device 100.

As perhaps best seen in comparing FIGS. 7 and 8, assuring that the power is switched on 90 degrees after the zero crossing of line voltage sets a timing upon cold start that avoids a spike on secondary winding 385 of transformer 380, as well as a further negative spike on capacitor 390. Based on the test example presented, through the use of the timing control system of the present invention, an approximately 2 kV spike on secondary winding 385 of transformer 380 and a negative 2 kV spike on capacitor 390 are avoided upon cold start activation of microwave heating device 100. Therefore, the control system of the invention provides optimum timing of the power supply switching thereby achieving consistent and minimum open circuit voltage starts for magnetrons 102 and 103 upon cold start.

Although described with reference to a preferred embodiment of the present invention, it should be readily apparent to one of ordinary skill in the art that various changes and/or modifications can be made to the invention without departing from the spirit thereof. For instance, although the cooking appliance discussed above employs two magnetrons, the invention is equally applicable to microwave ovens supplying a single magnetron. In addition, the exact circuitry utilized in connection with controlling the power supply switch timing could vary while still performing the desired function. In general, the invention is only intended to be limited by the scope of the following claims.

1. A cooking appliance comprising:
a cooking chamber including top, bottom, rear and opposing side walls, and a frontal opening;
a door shiftably mounted relative to the cooking chamber for selectively closing the frontal opening;
a magnetron for delivering a microwave energy field into the cooking chamber to selectively perform at least a portion of a cooking operation;
a power supply electrically connected to the magnetron, said power supply being adapted to receive a line voltage and output a voltage higher than the line voltage to the magnetron; and
a controller operatively connected to the power supply, said controller timing an application of initial power to the power supply such that the power supply is switched on ninety degrees after a zero crossing of the line voltage.

2. The cooking appliance according to claim 1, wherein the power supply includes a primary winding connected to the line voltage and a secondary winding coupled to the magnetron, wherein said controller times the application of initial power to the primary winding.

3. The cooking appliance according to claim 2, further comprising: a semiconductor device electrically coupled to the power supply in series between the line voltage and the primary winding.

4. The cooking appliance according to claim 3, wherein the controller regulates switching of the semiconductor device to switch on the power supply.

5. The cooking appliance according to claim 4, further comprising: a capacitor electrically coupled to the power supply in series between the secondary winding and the magnetron, wherein a midpoint of a charging half cycle of the capacitor coincides with the zero crossing of the line voltage.

6. A cooking appliance comprising:
a cooking chamber including top, bottom, rear and opposing side walls, and a frontal opening;
a door shiftably mounted relative to the cooking chamber for selectively closing the frontal opening;
means for delivering a microwave energy field into the cooking chamber to selectively perform at least a portion of a cooking operation;
power supply means electrically connected to the delivery means, said power supply means being adapted to receive a line voltage and output a voltage higher than the line voltage to the delivery means; and
means for controlling activation of the power supply means, said controlling means timing an application of initial power to the power supply means such that the power supply means is switched on ninety degrees after a zero crossing of the line voltage.

7. The cooking appliance according to claim 6, wherein the power supply means includes a primary winding connected to the line voltage and a secondary winding coupled to the delivery means, wherein said controlling means times the application of initial power to the primary winding.

8. The cooking appliance according to claim 7, further comprising: a semiconductor device electrically coupled to the power supply means in series between the line voltage and the primary winding.

9. The cooking appliance according to claim 8, wherein the controller means regulates switching of the semiconductor device to switch on the power supply means.

10. The cooking appliance according to claim 9, further comprising: a capacitor electrically coupled to the power supply means in series between the secondary winding and the delivery means, wherein a midpoint of a charging half cycle of the capacitor coincides with the zero crossing of the line voltage.

11. A method of controlling a cold start operation of a magnetron used to perform at least a portion of a cooking operation in a cooking appliance having a primary winding of a power supply connected to a line voltage and a secondary winding of the power supply connected to the magnetron comprising:
sensing a zero-crossing of the line voltage connected to the power supply; and
activating the power supply ninety degrees after the zero crossing of the line voltage to minimize open circuit voltage starts of the magnetron.

12. The method of claim 11, wherein activating the power supply is constituted by triggering a semiconductor device coupled in series between the line voltage and the primary winding of the power supply.

13. The method of claim 11, wherein activating the power supply is caused to coincide with a midpoint of a charging half cycle of a capacitor coupled to the power supply in series between the secondary winding and the magnetron.
